(19) United States
(12) Patent Application Publication
(10) Pub. No.: US 2018/0053107 A1
(43) Pub. Date: Feb. 22, 2018

(54) ASPECT-BASED SENTIMENT ANALYSIS

(71) Applicant: SAP SE, Walldorf (DE)

(72) Inventors: Wenya WANG, Singapore (SG); Daniel Hermann Richard DAHLMEIER, Singapore (SG); Sinno Jialin PAN, Singapore (SG); Xiaokui XIAO, Singapore (SG)

(21) Appl. No.: 15/241,098

(22) Filed: Aug. 19, 2016

(51) Int. Cl. G06N 7/00; G06N 99/00; G06N 3/08

(52) U.S. Cl. CPC G06N 7/005; G06N 3/08; G06N 99/005

(57) ABSTRACT

Described herein is a framework to perform aspect-based sentiment analysis. In accordance with one aspect of the framework, initial word embeddings are generated from a training dataset. A predictive model is trained using the initial word embeddings. The trained predictive model may then be used to recognize one or more sequences of tokens in a current dataset.

### TECHNICAL FIELD

The present disclosure relates generally to computer systems, and more specifically, to a framework for aspect-based sentiment analysis.

### BACKGROUND

With rapid development in e-commerce, product reviews have become a source of valuable information about products. Opinion mining generally aims to extract opinion targets, opinion expressions, target categories, opinion polarities or even summarize the reviews. In fine-grained analysis, each aspect or feature of the product is selected from the review, along with the opinion being expressed and the sentiment polarity. For example, in restaurant reviews “I have to say they have one of the fastest delivery times in the city.”, the aspect term is “delivery times”, and the opinion term is “fastest”, which is positive.

For this task, previous work generally adopts two different approaches. The first approach is to accumulate aspect terms and opinion terms from a seed collection, by utilizing syntactic rules or modification relations between aspects and opinions. For example, if we know “fastest” is an opinion word, then “delivery times” is deduced as an aspect because “fastest” is a modifier for the ones at behind. However, this approach relies on hand-coded rules, and is always restricted to certain Part-of-Speech tags. Other approaches focus on feature engineering from a huge availability of resources, including dictionaries and lexicons. This method is time-consuming and requires external resources to define useful features.

### SUMMARY

A framework for performing aspect-based sentiment analysis is described herein. In accordance with one aspect of the framework, initial word embeddings are generated from a training dataset. A predictive model is trained using the initial word embeddings to obtain high-level representations of relations between aspect terms and opinion terms in review sentences. The trained predictive model may then be used to recognize one or more sequences of tokens in a current dataset.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram illustrating an exemplary architecture;

FIG. 2 shows an exemplary method for performing aspect-based sentiment analysis;

FIG. 3 shows an exemplary word dependency structure;

FIG. 4 shows an exemplary recursive neural network based on a word dependency tree;

FIG. 5 shows an exemplary joint predictive model;

FIG. 6a shows a table that compares the performance of the present joint model (Dep-NN) and the top three models in the semEval challenge; and

FIG. 6b shows a table that compares the performance of two joint models.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for ease of understanding, certain method steps are delineated as separate steps; however, these separately delineated steps should not be construed as necessarily order dependent in their performance.

A framework for aspect-based sentiment analysis is described herein. One aspect of the present framework uses a deep recursive neural network to encode the dual propagation of pairs of aspect and opinion terms. An “aspect term” represents one or more features of a commodity (e.g., product, service), while an “opinion term” represents a sentiment expressed by a reviewer of the commodity. In most cases, the aspect term in a review sentence is strongly related to the opinion term because the aspect is the target of the expressed opinion. The recursive neural network may be trained to learn the underlying features of the input, by considering the relations between aspect and opinion terms.

In accordance with another aspect, a conditional random field (CRF) is applied on top of the neural network. Such joint model may be superior to common feature engineering because the features can be automatically learned through a dependency tree-based neural network. CRFs are used to make structured predictions in sequence tagging problems. By combining these two methods, the joint model advantageously takes into consideration context information and automatic feature representation for more accurate predictions.

It should be appreciated that the framework described herein may be implemented as a method, a computer-controlled apparatus, a computer process, a computing system, or as an article of manufacture such as a computer-usable medium. These and various other features and advantages will be apparent from the following description.

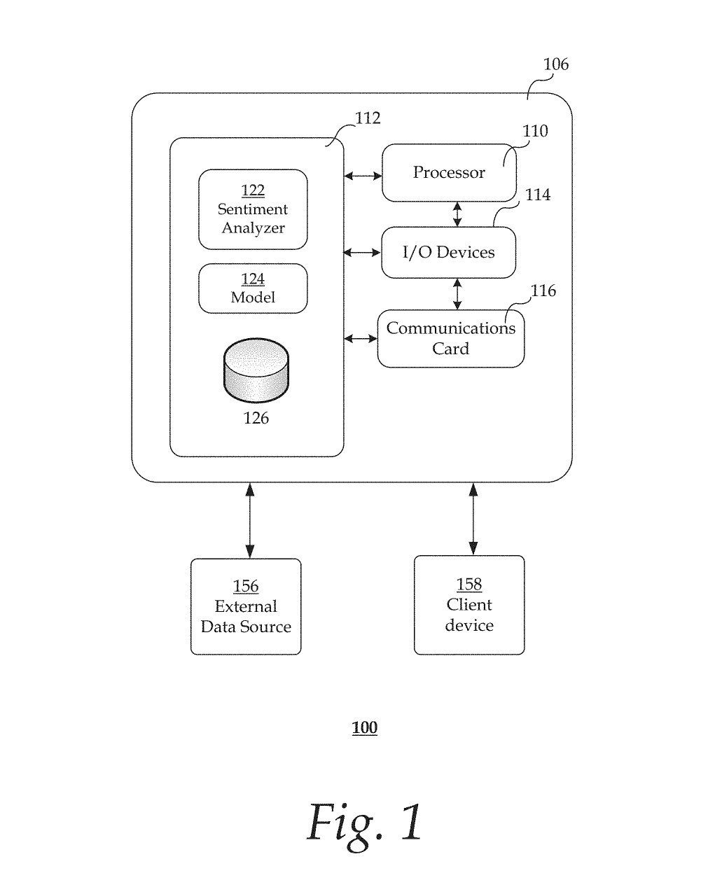

FIG. 1 is a block diagram illustrating an exemplary architecture 100 in accordance with one aspect of the present framework. Generally, exemplary architecture 100 may include a server 106, an external data source 156 and a client device 158.

Server 106 is a computing device capable of responding to and executing machine-readable instructions in a defined manner. Server 106 may include a processor 110, input/output (I/O) devices 114 (e.g., touch screen, keypad, touch pad, display screen, speaker, microphone, etc.), a memory module 112, and a communications card or device 116 (e.g., modem and/or network adapter) for exchanging data with a network (e.g., local area network or LAN, wide area network (WAN), Internet, etc.). It should be appreciated that the different components and sub-components of the server 106 may be located or executed on different machines or systems. For example, a component may be executed on many computer systems connected via the network at the same time (i.e., cloud computing).

Memory module 112 may be any form of non-transitory computer-readable media, including, but not limited to, dynamic random access memory (DRAM), static random access memory (SRAM), Erasable Programmable Read-Only Memory (EPROM), Electrically Erasable Programmable Read-Only Memory (EEPROM), flash memory devices, magnetic disks, internal hard disks, removable disks or cards, magneto-optical disks, Compact Disc Read-Only Memory (CD-ROM), any other volatile or non-volatile memory, or a combination thereof. Memory module 112 serves to store machine-executable instructions, data, and various software components for implementing the techniques described herein, all of which may be processed by processor 110. As such, server 106 is a general-purpose computer system that becomes a specific-purpose computer system when executing the machine-executable instructions. Alternatively, the various techniques described herein may be implemented as part of a software product. Each computer program may be implemented in a high-level procedural or object-oriented programming language (e.g., C, C++, Java, JavaScript, Advanced Business Application Programming (ABAP™) from SAP® AG, Structured Query Language (SQL), etc.), or in assembly or machine language if desired. The language may be a compiled or interpreted language. The machine-executable instructions are not intended to be limited to any particular programming language and implementation thereof. It will be appreciated that a variety of programming languages and coding thereof may be used to implement the teachings of the disclosure contained herein.

In some implementations, memory module 112 includes a sentiment analyzer 122, a predictive model 124 and database 126. Database 126 may include, for example, a training dataset for training predictive model 124 and a current dataset that the predictive model 124 can be applied on to make predictions. Server 106 may operate in a networked environment using logical connections to external data source 156 and client device 158. External data source 156 may provide data for training and/or applying the model 124. Client device 158 may be used to, for example, configure and/or access the predictive results provided by sentiment analyzer 122.

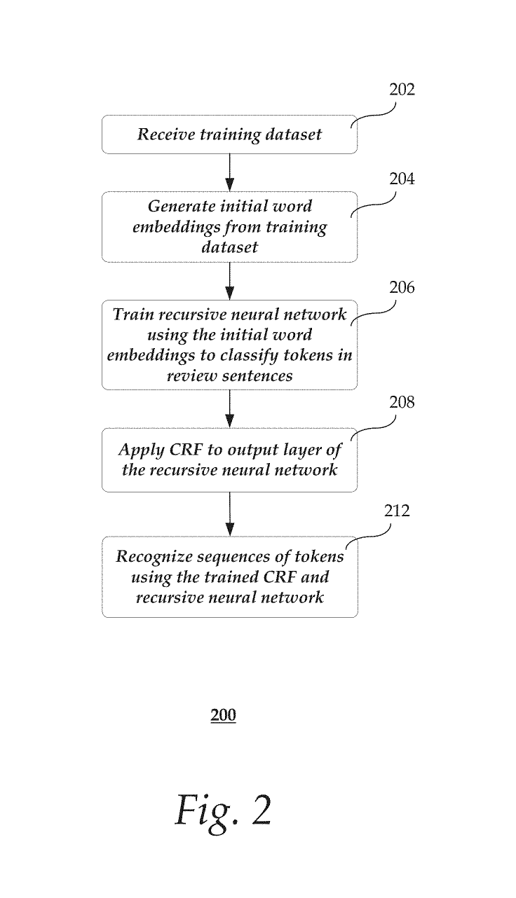

FIG. 2 shows an exemplary method 200 for performing aspect-based sentiment analysis. The method 200 may be performed automatically or semi-automatically by the system 100, as previously described with reference to FIG. 1. It should be noted that in the following discussion, reference will be made, using like numerals, to the features described in FIG. 1.

At 202, sentiment analyzer 122 receives a training dataset. The training set may include a set of review sentences. Each review sentence in the training set includes tokens that are labeled (or tagged) as one class among multiple classes. In some implementations, each token is labeled as one class among 5 classes: “BA” (beginning of aspect), “IA” (inside of aspect), “BO” (beginning of opinion), “IO” (inside of opinion) and “O” (outside of aspect and opinion). The problem becomes a standard sequence labeling (or tagging) problem, which is generally a type of pattern recognition task that involves the algorithmic assignment of a categorical label to each token of a sequence of observed values.

At 204, sentiment analyzer 122 generates initial word embeddings from the training dataset. A “word embedding” generally refers to a vector of real numbers that represent a word. Such word embeddings (or word vectors) are positioned in the vector space such that words that share common contexts in the corpus are located in close proximity to one another in the space, thereby providing distributed representations about the semantic and syntactic information contained in the words.

A model may be trained from a large corpus in an unsupervised manner to generate word embeddings (or word vectors) from the training dataset as a starting point. In some implementations, a shallow, two-layer neural network is trained to reconstruct the semantically meaningful word embeddings with a predetermined length. See, for example, Tomas Mikolov, Ilya Sutskever, Kai Chen, Gregory S. Corrado, and Jeffrey Dean, “Distributed representations of words and phrases and their compositionality,” Advances in Neural Information Processing Systems 26: 27th Annual Conference on Neural Information Processing Systems 2013, pages 3111-3119, 2013, which is herein incorporated by reference. Other methods are also useful.

After training, the word embeddings may be stored in a dictionary for initializing word embeddings in a recursive neural network, as will be discussed with respect to the next step 206. Formally speaking, each word w in the dictionary corresponds to a vector x_{w}εR_{d}, wherein R is a set of real numbers and d is the vector length.

At 206, sentiment analyzer 122 constructs a word dependency structure based on the initial word embeddings. The word dependency structure (e.g., tree structure) represents the grammatical structure of sentences, such as which groups of words go together (as “phrases”) and which words are the subject or object of a verb.

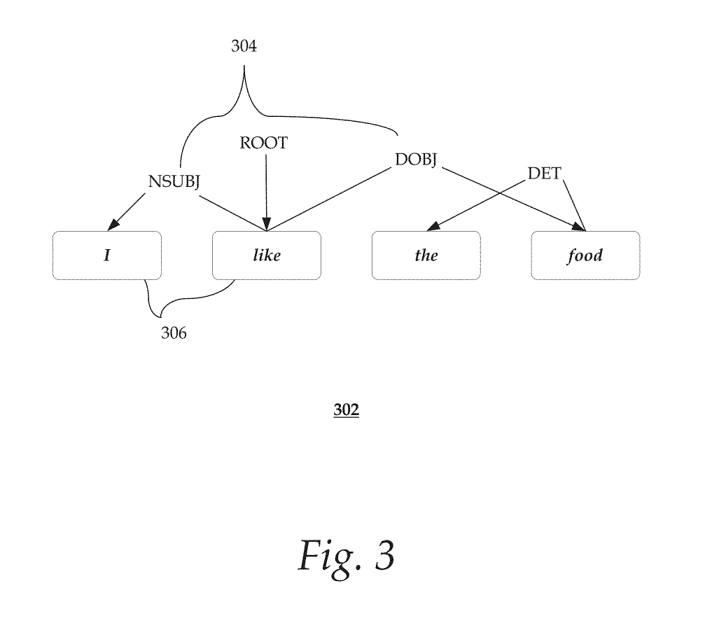

FIG. 3 shows an exemplary word dependency structure 302. Each arrow starts from the parent (e.g., 304) and points to its dependent (e.g., 306) with a specific relation. The leaf nodes 306 represent unique words, while the non-leaf nodes 304 represent the specific relations. For example, the word “I” is a subject (NSUBJ) of the verb “like”. As another example, the word “food” is the object (DOBJ) of the verb “like”. As yet another example, the word “the” goes together (DET) with the word “food”. The dependency structure 302 may be constructed by processing the initial word embeddings using a natural language parser, such as the Stanford parser. See, for example, Danqi Chen and Christopher D Manning, 2014, “A Fast and Accurate Dependency Parser using Neural Networks,” Proceedings of EMNLP 2014, which is herein incorporated by reference.

At 208, sentiment analyzer 122 trains a predictive model 124 using the word dependency structure to obtain high-level representations of relations between aspect terms and opinion terms in review sentences. The high-level feature representations may then be used to classify the tokens into, for example, one of the 5 classes (e.g., “BA”, “IA”, “BO”, “IO” and “O”). In some implementations, the predictive model 124 is a recursive neural network. A recursive neural network is a deep neural network created by applying the same set of weights recursively over a structure, to produce a structured prediction over variable-length input, or a scalar prediction on it, by traversing a given structure in topological order.

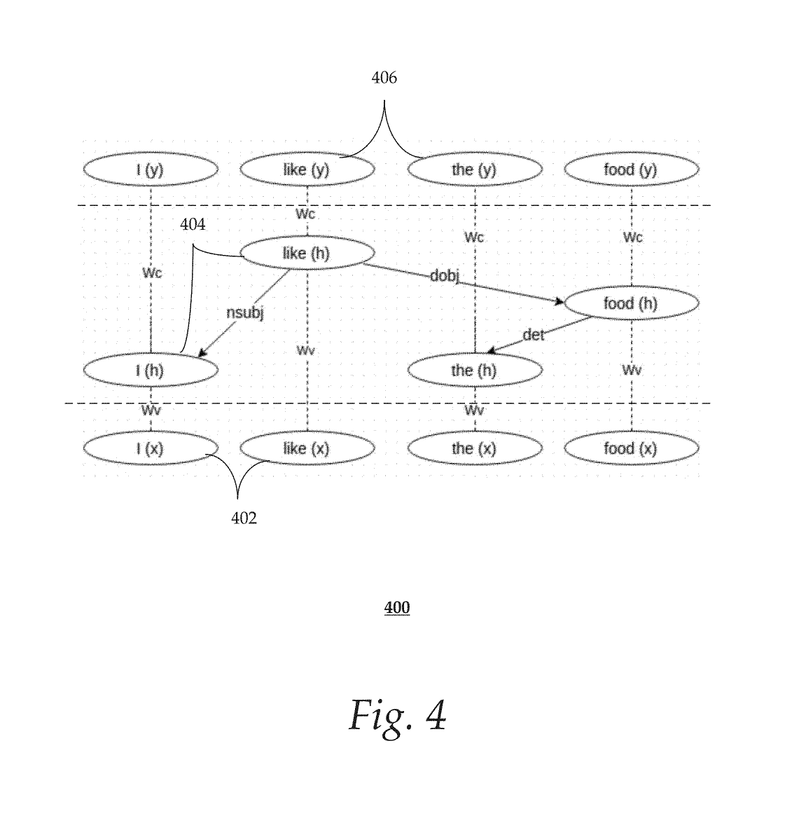

FIG. 4 shows an exemplary recursive neural network 400 based on a word dependency tree. The recursive neural network 400 includes input nodes 402 associated with input word vectors x, hidden nodes 404 associated with hidden vectors h, and output nodes 406 associated with output word vectors y. More particularly, each input leaf node 402 represents a unique word, and is associated with an input word vector which is extracted from the dictionary. The hidden word vector hₙεR_{d} is computed from its own word embedding and its dependencies' hidden word vectors. Each dependency relation r (e.g., nsubj, dobj, det) is associated with a separate d×d matrix Wᵣ to transform the input word the hidden representation h of any dependent token. Each input node 402 is associated with an input matrix Wᵥ to transform the input word embedding x, and each hidden node 404 is associated with an output matrix W_{c} to transform the hidden word embedding h to generate the predicted label y. Given the known labels, the cross-entropy function is used as the loss function for softmax prediction, wherein the error is computed as follows:

$$E = - {\sum }_{i} {t}_{i} log {y}_{i}$$

The error may then be backpropagated to all the parameters and word vectors (or embeddings) of the network 400.

As can be observed from the network 400, the recursive neural network is able to capture and learn the underlying relation between aspect terms and opinion terms. For example, in FIG. 4, “like” is the head of the word “food” with the relation DOBJ. After training, the network 400 is able to identify “like” as the opinion term or “food” as the aspect term from the dual effect after the transformation with the relation matrix.

In other implementations, the predictive model 124 is a joint model including both the recursive neural network and one or more CRFs applied to the output layer of the recursive neural network to predict sequences of tokens. CRFs are a type of discriminative undirected probabilistic graphical model that takes context (i.e., neighboring words) into account, so that they may predict which tokens belong together in a class. Since the neural network itself only makes separate predictions for each token in the review sentence, it may lose some context information. This is revealed by failing to distinguish between the beginning and inside of target class. The situation can be well handled by CRFs, which model the effect of surrounding context to predict sequences of tokens. Conventional use of CRFs greatly relies on the choice and design of input features, which is time-consuming and knowledge-dependent. The hand-engineered features only achieve moderate performance due to linearity. In contrast, neural networks exploit higher-level features by non-linear transformation. In the present framework, the neural network is combined with CRFs, where the output of neural network is provided as the input features for the CRFs.

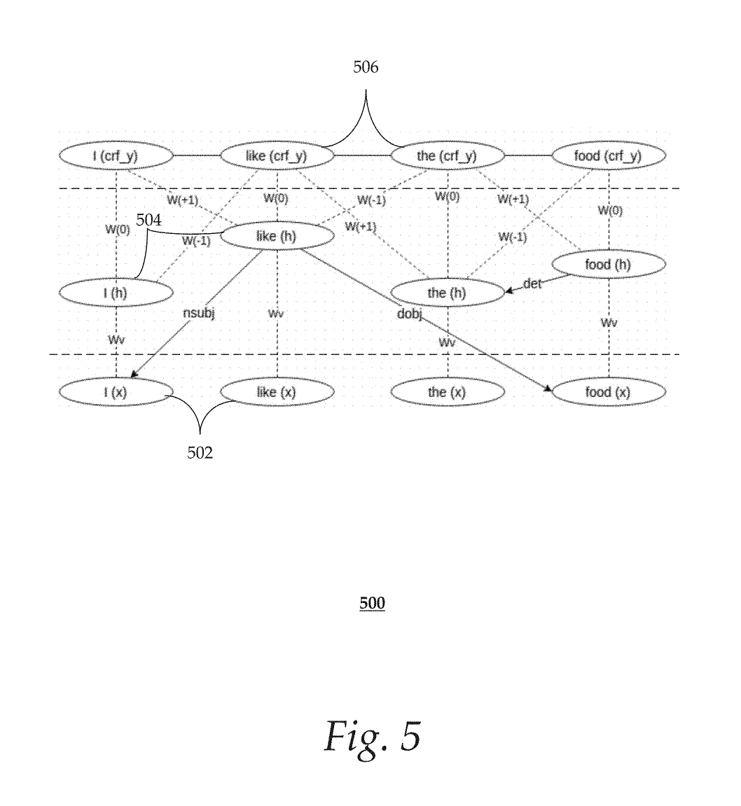

FIG. 5 shows an exemplary joint predictive model 500. The joint model 500 includes input layer nodes 502, hidden layer nodes 504 and output layer nodes 506. At initialization, the parameters for the trained recursive neural network are restored. In this joint model, the input vectors and hidden vectors are computed in the same manner as described with reference to FIG. 4 for the recursive neural network 400, except for the last output layer 506, where a linear chain of CRFs (crf_y) is applied. Each CRF takes the final hidden representation of each output layer node as the input feature.

A context window with a predetermined size (e.g., 1) may be applied for prediction at each position. For example, at the second position, features for the word “like” are composed of the hidden vector at position 1, position 2 and position 3. The weight matrices are initialized to zero. The joint model is trained with the objective of maximizing the log-probability of the training sequences given the inputs. By taking the gradient, the errors can be back propagated all the way to the input leaf nodes 502. More particularly, parameter updates are carried through backpropagation until the leaves of the dependency tree (i.e., the word vectors) are reached.

Returning to FIG. 2, at 210, sentiment analyzer 122 recognizes sequences of tokens in a current dataset using the trained predictive model. The predictive model may be applied to, for example, classify sequences of tokens in a current dataset of restaurant review sentences. Each token may be recognized (or classified) as one class among 5 classes: “BA” (beginning of aspect), “IA” (inside of aspect), “BO” (beginning of opinion), “IO” (inside of opinion) and “O” (outside of aspect and opinion). The recognized tokens may then be summarized to provide information about the sentiments of the customers or reviewers regarding specific aspects.

With the help of deep learning, non-linear high-level features may be learned to encode the underlying dual propagation of aspect-opinion pairs. In the meantime, CRFs may make better predictions given the surrounding context. Different from the previous approaches, this joint model outperforms the traditional rule-based methods in terms of flexibility, because aspect terms and opinion terms are not only restricted to certain observed relations and part-of-speech (POS) tags. Compared to feature engineering in common CRF models, this method saves much effort in composing features, and it is able to extract higher-level features obtained from non-linear transformations. Moreover, the aspect terms and opinion terms may be exploited in a single operation.

To compare the performance of the different models, the top three models from the semEval challenge by Pontiki et al. [2014] are compared to the present joint model. See Maria Pontiki, Dimitris Galanis, John Pavlopoulos, Harris Papageorgiou, Ion Androutsopoulos, and Suresh Manandhar, Semeval-2014 task 4: Aspect based sentiment analysis, Proceedings of the 8th International Workshop on Semantic Evaluation (SemEval 2014), pages 27-35, Dublin, Ireland, 2014, which is herein incorporated by reference.

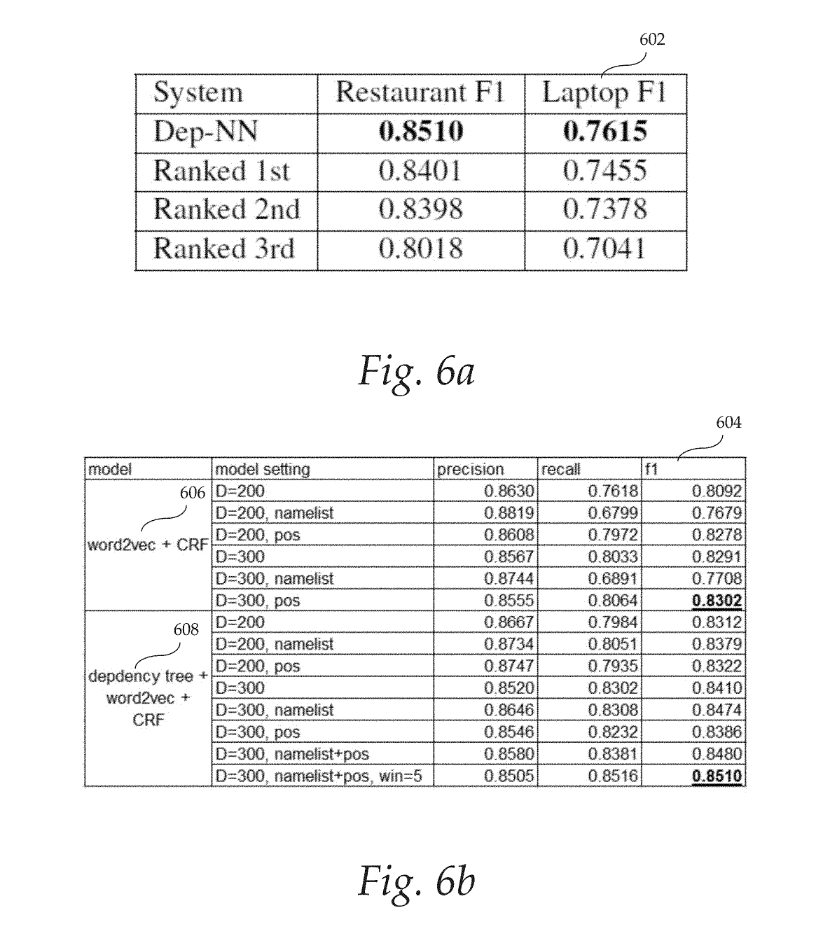

FIG. 6a shows a table 602 that compares the performance of the present joint model (Dep-NN) and the top three models in the semEval challenge. The present joint model (Dep-NN) uses the combination of dependency tree, recursive neural network and CRF (i.e., dependency tree-based recursive neural network) to make sequence predictions.

FIG. 6b shows a table 604 that compares the performance of 2 joint models (606, 608). In order to show the advantage of dependency tree-based recursive neural network, another model 606 which consists only of word2vec training and CRF prediction is constructed for comparison. More particularly, the first joint model 606 uses only the word2vec tool for training word vectors, with CRF directly applying on top, while the second joint model 608 uses the dependency tree, word2vec and CRF to make predictions. The F1 scores shown represent the performance of aspect term extraction.

The word embeddings were trained based on the same dataset, and the final word vectors were provided as the input features for CRF. Hand-engineered features were also added as extra features for the CRF. By adding these features, the input is fixed, while neural network inputs and CRF weights are updated. The effect of adding namelist features and POS tags was observed. The namelist features were inherited from the best model in semEval Toh and Wang [2014] (see Zhiqiang Toh and Wenting Wang. Dlirec, Aspect term extraction and term polarity classification system, Proceedings of the 8th International Workshop on Semantic Evaluation (SemEval 2014), pages 235-240, Dublin, Ireland, 2014, which is herein incorporated by reference), where 2 sets of namelists were constructed with one including high-frequency aspect terms, and the other including high-probability aspect words. For POS tags, the Penn treebank was implemented and converted to universal POS tags that include 15 different categories.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A system for sentiment analysis, comprising:
a non-transitory memory device for storing computer-readable program code; and
a processor in communication with the memory device, the processor being operative with the computer-readable program code to perform operations comprising
receiving a training dataset,
generating initial word embeddings from the training dataset,
constructing a word dependency structure based on the initial word embeddings,
training a predictive model using the word dependency structure, wherein the predictive model comprises a recursive neural network and one or more conditional random fields applied to an output layer of the recursive neural network, and
recognizing one or more sequences of tokens in a current dataset using the trained predictive model.

2. The system of claim 1 wherein the training dataset comprises a set of review sentences, wherein at least one of the review sentences includes labeled tokens.

3. The system of claim 2 wherein the labeled tokens are tagged as “beginning of aspect”, “inside of aspect”, “beginning of opinion”, “inside of opinion” or “outside of aspect and opinion”.

4. The system of claim 1 wherein the word dependency structure comprises a tree structure that represents a grammatical structure.

5. A method of sentiment analysis, comprising:
receiving a training dataset;
generating initial word embeddings from the training dataset;
training a predictive model based on the initial word embeddings; and
recognizing one or more sequences of tokens in a current dataset using the trained predictive model.

6. The method of claim 5 wherein generating the initial word embeddings comprises training a neural network to reconstruct the initial word embeddings.

7. The method of claim 5 further comprises constructing a word dependency structure based on the initial word embeddings for training the predictive model.

8. The method of claim 7 wherein the word dependency structure comprises a tree structure that represents a grammatical structure.

9. The method of claim 5 wherein training the predictive model comprises training a recursive neural network.

10. The method of claim 5 wherein training the predictive model comprises training a joint model including a recursive neural network with one or more conditional random fields applied to an output layer of the recursive neural network.

11. The method of claim 10 wherein each of the conditional random field takes a hidden representation of an output layer node as an input feature.

12. The method of claim 10 further comprises back propagating errors to leaf nodes of the recursive neural network.

13. The method of claim 5 wherein recognizing the one or more sequences of tokens comprises classifying each of the tokens as “beginning of aspect”, “inside of aspect”, “beginning of opinion”, “inside of opinion” or “outside of aspect and opinion”.

14. The method of claim 5 wherein recognizing the one or more sequences of tokens comprises identifying each of the tokens as an opinion term or an aspect term.

15. The method of claim 5 wherein receiving the training dataset comprises receiving a set of review sentences, wherein at least one of the review sentences includes labeled tokens.

16. The method of claim 15 wherein the labeled tokens are tagged as “beginning of aspect”, “inside of aspect”, “beginning of opinion”, “inside of opinion” or “outside of aspect and opinion”.

17. A non-transitory computer-readable medium having stored thereon program code, the program code executable by a computer to perform steps comprising:
receiving a training dataset;
generating initial word embeddings from the training dataset;
training a predictive model based on the initial word embeddings; and
recognizing one or more sequences of tokens in a current dataset using the trained predictive model.

18. The non-transitory computer-readable medium of claim 17 wherein training the predictive model comprises training a recursive neural network.

19. The non-transitory computer-readable medium of claim 17 wherein training the predictive model comprises training a joint model including a recursive neural network with one or more conditional random fields applied to an output layer of the recursive neural network.

20. The non-transitory computer-readable medium of claim 17 wherein recognizing the one or more sequences of tokens comprises classifying each of the tokens as “beginning of aspect”, “inside of aspect”, “beginning of opinion”, “inside of opinion” or “outside of aspect and opinion”.
